(19) United States
(12) Patent Application Publication
(10) Pub. No.: US 2009/0161832 A1
(43) Pub. Date: Jun. 25, 2009

(54) Device for Generating X-Ray Images

(75) Inventor: Ruedi G. Laupper, Hitzkirch (CH)

Correspondence Address: THE NATH LAW GROUP, 112 South West Street, Alexandria, VA, 22314, US

(73) Assignee: SWISSRAY INTERNATIONAL INC., Elizabeth, NJ (US)

(21) Appl. No.: 12/085,311

(22) PCT Filed: Nov. 24, 2005
(86) PCT No.: PCT/EP2005/056190

§ 371 Date: May 21, 2008

(51) Int. Cl. H01J 31/49

(52) U.S. Cl. 378/189

(57) ABSTRACT

A device for generating real-time X-ray images has a housing in which a digital X-ray image sensor is arranged, and a holding arrangement that can be connected to an X-ray appliance with a radiation source. The housing is secured on the holding arrangement via a floating and/or oscillatory suspension. The suspension comprises a support ring which on the one hand is connected with the aid of shock-absorber elements to the holding arrangement and on the other hand is connected with the aid of shock-absorber elements to the housing.

The invention relates to a device for generating X-ray images in accordance with the preamble of claim 1.

Digital radiography is increasingly replacing conventional X-ray technology. Digital X-ray technology is described, for example, in WO 96/22654. Generically comparable devices for generating X-ray images are also known to a person skilled in the art by the name “Bucky”. They have a housing in which a digital X-ray image sensor is arranged. With known “Buckys”, the housing is connected directly to a frame of an X-ray installation. The X-ray image sensor is insufficiently protected against shocks to the Bucky owing to this arrangement. In particular, so-called flat panel detectors for generating real-time X-ray images are very sensitive to shocks.

It is therefore an object of the invention to avoid the disadvantages of what is known, in particular to create a device of the type named at the beginning that provides good protection against effects from outside such as, for example, shocks. At the same time, the device is to be easy to use and, in particular, be capable of being easily mounted and dismounted. These objects are achieved according to the invention with the aid of a device which has the features in claim 1.

A floating and/or oscillating suspension enables a compensating movement of the housing in all spatial directions. In particular, shocks that act on the housing perpendicular to, and in the direction of, the image recording plane of the X-ray image sensor can be absorbed. It is thereby possible for the housing also to execute compensating movements for the purpose of absorbing shocks without the holding arrangement, which is to assume a fixed position, being moved. The sensitive X-ray image sensor is thereby optimally protected against external mechanical effects. The holding arrangement can be assigned to a stationary frame of an X-ray installation. Such frames must, of course, not be directly connected to the X-ray machine with the radiation source.

In a first embodiment, the X-ray image sensor is assigned to the holding arrangement. Here, the X-ray image sensor is directly connected to the holding arrangement, in which case it can preferably be detachably fastened to the holding arrangement. This embodiment has the advantage that X-ray images of constantly high quality are possible at least in the case of shocks of relatively low intensity.

The holding arrangement can be connected to a transmission unit by a first shock absorber arrangement. For its part, the transmission unit can be connected to the housing by a second shock absorber arrangement. The first and the second shock absorber arrangements in this case respectively have at least one shock absorber element. With the aid of the transmission unit, the housing can be ideally suspended from the holding arrangement in a floating and/or oscillating fashion. These shock absorber arrangements can, for example, respectively have four shock absorber elements. Such an arrangement would, for example, be advantageous in the event of using a rectangular X-ray image sensor (in a plan view of the image recording plane). Metal springs or springs made from an elastomer (so-called “rubber springs”), inter alia, come into consideration as shock absorber elements, for example.

The transmission unit can be rigid, in particular can be designed as a rigid component. It preferably consists of a metallic material.

The transmission unit can be designed as a rectangular carrier ring. Here, the rectangular ring shape is seen in a plan view of a principal side of the transmission unit, at least in a rest position the principal side running approximately plane-parallel relative to the image recording plane of the X-ray image sensor. A carrier ring as rigid component has various advantages. Thus, it has advantageous mechanical properties. Furthermore, it also leaves sufficient space for the integration of cables and other electronic components. However, it would also be conceivable to design the transmission unit as a preferably approximately rectangular plate.

The shock absorber elements of the first shock absorber arrangement and of the second shock absorber arrangement can be supported on one side on a top side, facing the holding arrangement, of the transmission unit. This arrangement has the advantage that the suspension is easily accessible and so can be mounted and dismounted in a particularly simple way.

For ease of mountability, the transmission unit can further be connected to the shock absorber elements with the aid of quick-acting closures. The quick-acting closure can have a tool holder for a mounting tool. The tool holder in this case is advantageously configured to be accessible from the top side of the transmission unit, which is averted from the holding arrangement, the result being to ensure quick mounting and dismounting.

A bearing surface can be provided in order to support the shock absorber elements of the second shock absorber arrangement on the housing. In this case, in a rest position the bearing surface can run approximately plane-parallel relative to the image recording plane of the X-ray image sensor. The bearing surface may, for example, be assigned to a fastening corner element that is detachably connected to the housing.

It can be advantageous when each side of the shock absorber elements of the first and the second shock absorber arrangement are supported on supporting surfaces that respectively lie in the rest position on common planes. This arrangement has the advantage that the same shock absorber elements can be used both for the first shock absorber arrangement and for the second shock absorber arrangement. Consequently, the outlay on production and the costs per shock absorber element can be lowered. In this case, one of the supporting surfaces or its associated plane would be prescribed by the transmission unit. On the other hand, the bearing surface for supporting the shock absorber elements of the second shock absorber arrangement would need to be arranged on the housing in such a way that in its rest position it runs in the plane of the top side of the holding arrangement.

The shock absorber element of the first shock absorber arrangement, and/or the shock absorber elements of the second shock absorber arrangement include spring elements, preferably helical springs and, particularly preferably, conically designed helical compression springs. The use of spring elements has the advantage that a shock absorber element can be produced easily and relatively cost effectively. Experiments have shown that an optimum suspension results, particularly when use is made of conical helical compression springs. A further advantage of conical helical compression springs is that they are distinguished by a short block length.

Each shock absorber element of the first shock absorber arrangement and/or each shock absorber element of the second shock absorber arrangement can respectively have a spring element. However, depending on the aim of the application, it would also be conceivable to provide a number of spring elements per shock absorber element.

The shock absorber elements of the first shock absorber arrangement and/or the shock absorber elements of the second shock absorber arrangement can include spring elements whose spring axes run perpendicular to the image recording plane of the X-ray image sensor in the rest position.

The shock absorber elements may be provided with securing means. This also leads, in particular, to a restriction of the movement of the housing and/or of the transmission unit in the event of shocks. Damage to the X-ray image sensor by mechanical action can thereby be ruled out in practice.

The holding arrangement can be connected to the housing on at least one side by at least one additional spring element. A respective additional spring element can have a spring axis that runs parallel to the corresponding side in the image recording plane of the X-ray image sensor. It is particularly preferred to be able to use wire cable spring elements as additional spring elements. Such a third shock absorber arrangement further increases the protection against shocks. The third shock absorber arrangement can be used as a type of second damping stage that comes to bear, in particular, only in the event of shocks with a relatively long travel. The first damping stage would then be prescribed by the abovenamed first and second shock absorber arrangement. However, it would also be conceivable, as an alternative, to equip a conventional Bucky—without first and second shock absorber arrangement—with wire cable spring elements.

It can be particularly advantageous when at least one wire cable spring element is respectively arranged in the region of the side of the holding arrangement opposite a holding arm, and in the region of the transverse sides of the holding arrangement adjoining said side.

The housing can be assembled from two housing shells. This embodiment is distinguished by advantageous handling. Thus, for example, maintenance work can be carried out easily by removing a detachable housing shell.

Fastening means for detachably fastening an antiscatter grid for producing special X-ray images can be provided on the housing in the region of an image recording side. Fastening means for detachably fastening the antiscatter grid in a storage position can be provided on the housing on the rear side opposite the image recording side. Such an arrangement for a Bucky has advantages with regard to handling. In particular, it would be ensured that an antiscatter grid could be mounted quickly if required. This arrangement could, of course, also be advantageous with a conventional Bucky.

At least one outwardly directed motion detector for monitoring movements in the surroundings of the housing can be provided on the housing. Laser light barriers, for example, can be used as motion detectors. Motion detectors can, for example, be arranged in the corner regions of the housing. It is preferably possible to provide two motion detectors that can respectively be arranged in the corner regions averted from the holding arm. It is thereby possible, in particular, to improve personal protection considerably.

In addition or as an alternative, it is possible to provide in the housing at least one sensor for monitoring shocks. In this case, the sensor can be fastened on the holding arrangement. In order to monitor shocks, the sensor can pick up movements of the transmission unit and/or of the housing. A system operating with laser light, for example, can be used as sensor. It is thereby possible to avoid X-ray images of insufficient quality. Of course, however, other sensor systems are also conceivable for detecting shocks. The use of acceleration sensors is also conceivable.

One aspect of the invention relates to an X-ray machine having a radiation source for emitting X-rays, and having a device for generating real-time X-ray images. Said device can be provided with motion detectors for monitoring movements in the surroundings of the housing and/or sensors for monitoring shocks. The motion detectors and/or sensors are connected to a control unit via which a radiographic procedure can be switched off automatically upon signaling of movements in the surroundings of the housing or given critical shocks. It is thereby possible to optimize the process safety of the X-ray machine further. Such an arrangement with motion detectors for monitoring movements in the surroundings of the housing, and/or with sensors for monitoring shocks could, of course, also be used with conventional Buckys. Alternatively or in addition, the arrangement could be connected to a warning system for signaling in the event of critical shocks.

Further advantages and individual features of the invention emerge from the drawings and from the following description of exemplary embodiments. In the drawings:

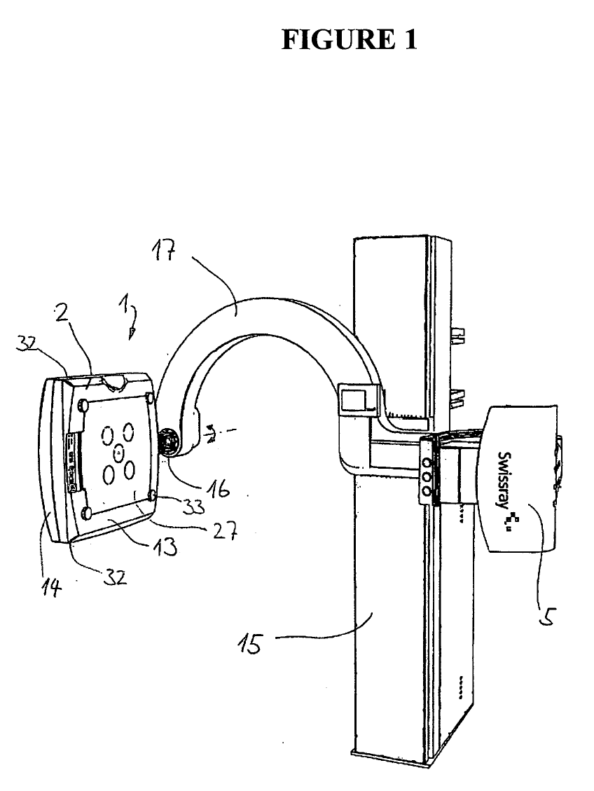

FIG. 1 shows a perspective illustration of an X-ray installation having a device for generating real-time X-ray images (Bucky) and a radiation source,

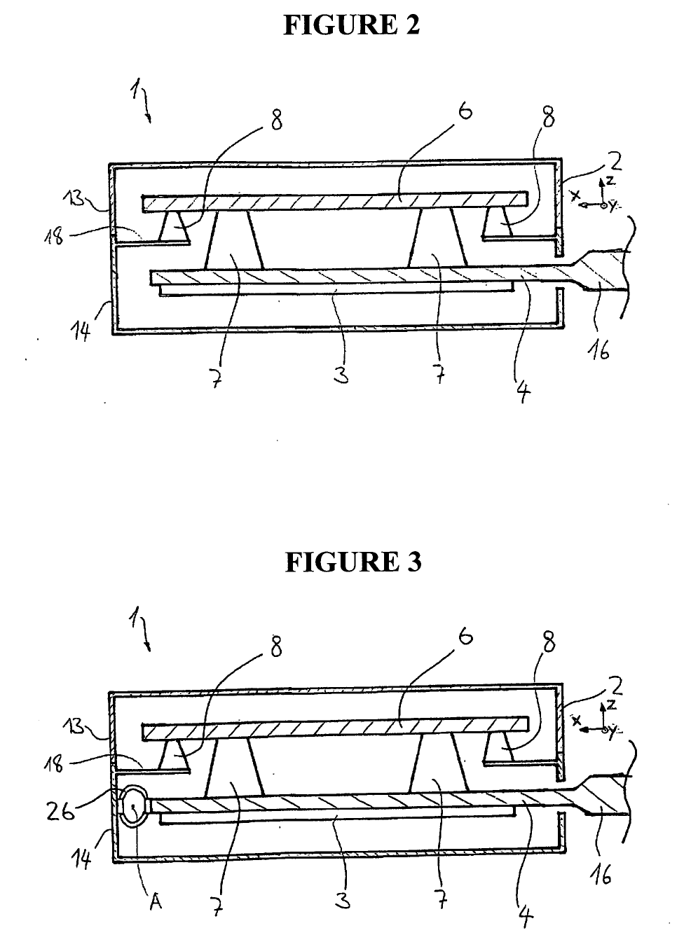

FIG. 2 shows a schematic of a Bucky,

FIG. 3 shows an embodiment of the Bucky in accordance with FIG. 2,

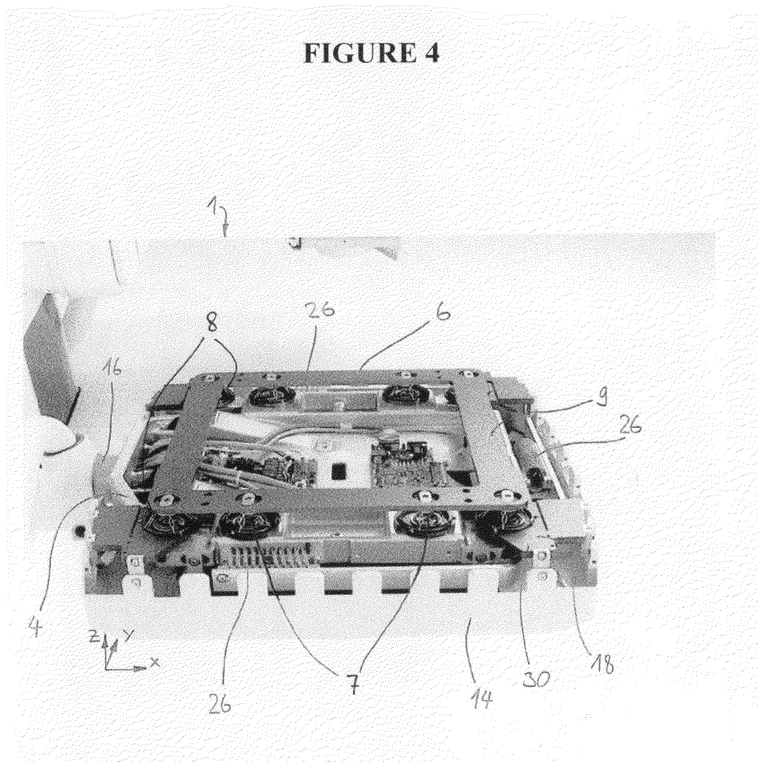

FIG. 4 shows a perspective illustration of a Bucky with housing shell removed,

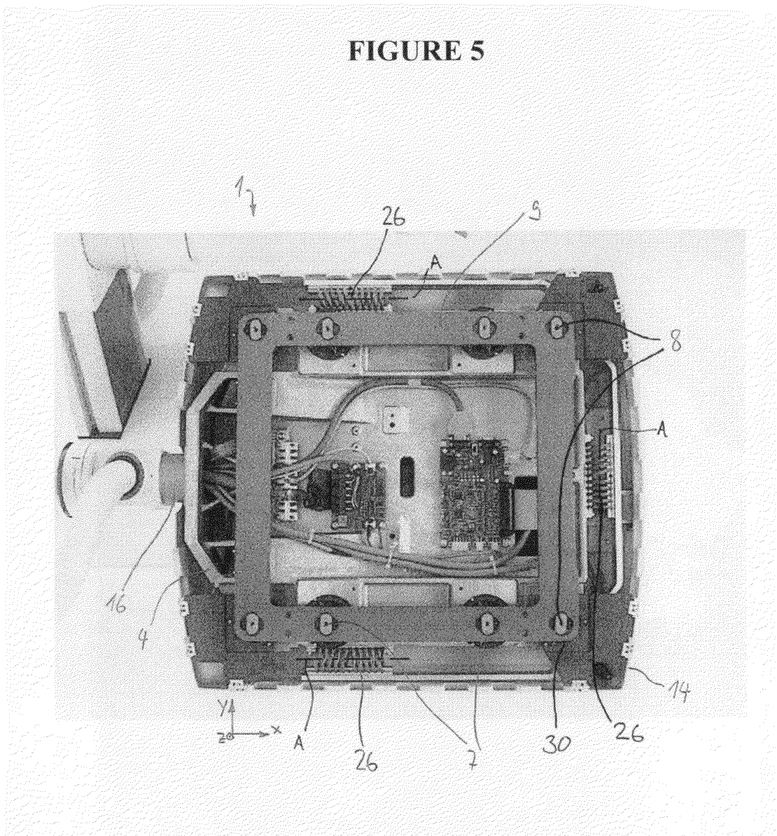

FIG. 5 shows a plan view of the Bucky in accordance with figure 4,

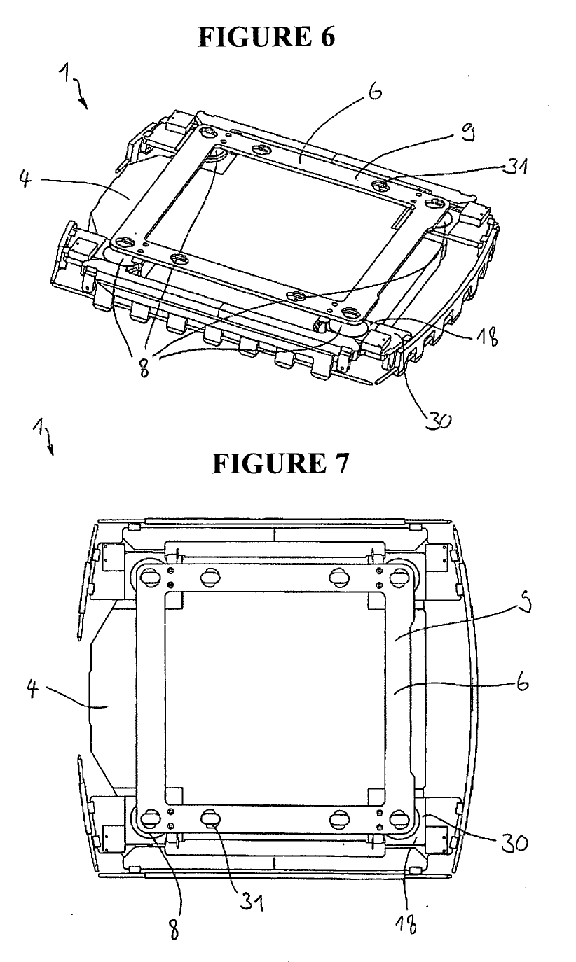

FIG. 6 shows a perspective illustration of the mechanical structure of a Bucky,

FIG. 7 shows a plan view of a Bucky in accordance with FIG. 6,

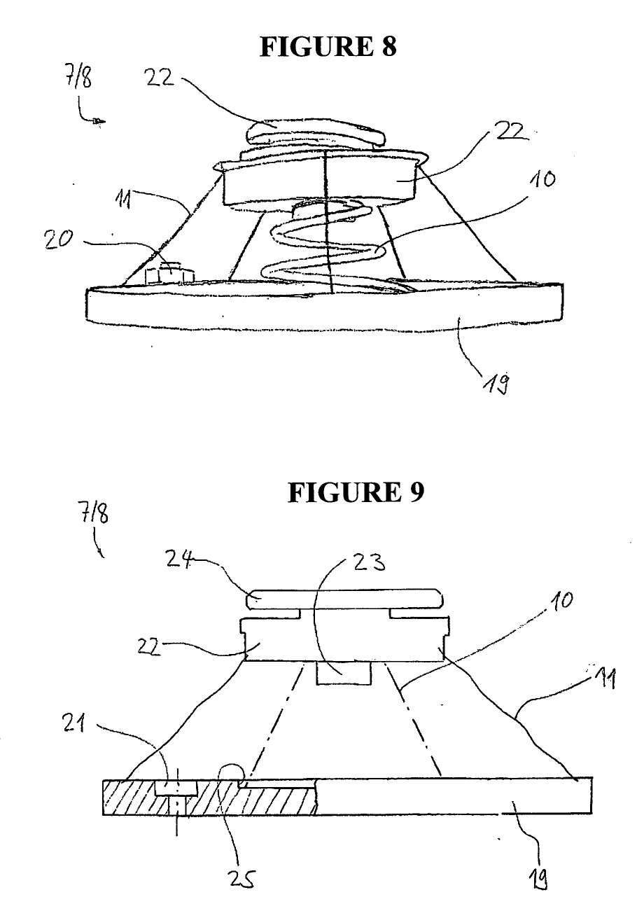

FIG. 8 shows a perspective, simplified illustration of a shock absorber element for a first or second shock absorber arrangement,

FIG. 9 shows a side view with partial section through the shock absorber element in accordance with FIG. 8,

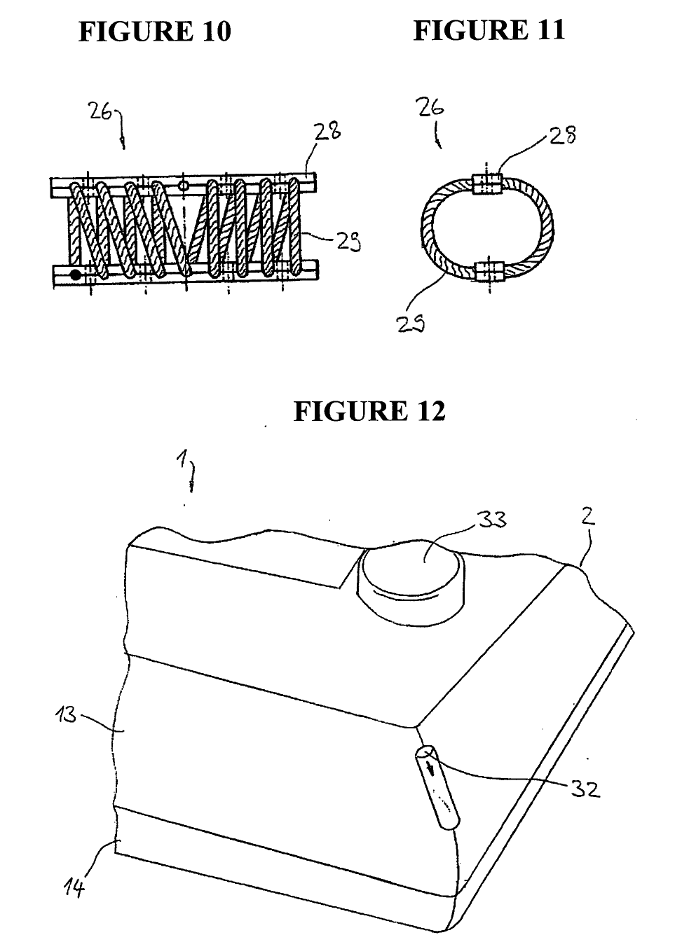

FIG. 10 shows a side view of a shock absorber element for a third shock absorber arrangement,

FIG. 11 shows a front view of the shock absorber element in accordance with FIG. 10, and

FIG. 12 shows a perspective illustration of a corner region of a housing of the Bucky.

In accordance with FIG. 1, an X-ray installation comprises a frame 15 on which an X-ray machine with a radiation source 5 is movably supported. The X-ray machine with the radiation source 5 is connected via a cantilever arm 17 and a holding arm 16 to a device for generating real-time X-ray images, the so-called Bucky. Of course, the radiation source, on the one hand, and the Bucky together with the frame, on the other hand, could be separate from one another or be integrated in different devices. The cantilever arm 17 can be displaced vertically on the frame 15. The Bucky 1 is supported on the cantilever arm 17 such that it can swivel.

Also to be seen from FIG. 1 is an antiscatter grid 27 that is fastened on the image recording side of the housing 2 with the aid of detachable fastening means 33. The antiscatter grid 27 can thus be easily dismounted and, for example, be mounted in a storage position on the rear side of the Bucky opposite the image recording side.

It is further to be seen from FIG. 1 that motion detectors 32 for monitoring movements in the surroundings of the housing 2 are provided on the housing. By way of example, the intention is to use these motion detectors to prevent a third person from being able to disturb the operation of taking X-ray images while it is underway. When movements are signaled, the X-ray machine therefore switches off, thus stopping the operation of taking X-ray images. Two motion detectors 32 that are arranged in corner regions of the housing 2 are to be seen in the present exemplary embodiment (compare FIG. 12).

FIG. 2 shows the principle of the design of a Bucky 1. A digital X-ray image sensor 3 is arranged in a housing 2. Said sensor is fastened on a holding arrangement 4 that, for its part, is connected to the holding arm (FIG. 1). The housing 2 is fastened on the holding arrangement 4 via a floating and/or oscillating suspension in order to protect against shocks. To this end, the suspension has a rigid transmission unit 6 that is connected to the holding arrangement 4 by a first shock absorber arrangement with shock absorber elements 7. The transmission unit 6 is then connected to the housing 2 by a second shock absorber arrangement with shock absorber elements 8. The shock absorber elements 7 and 8 are designed in such a way that they permit a movement of the housing 2 perpendicular to the image recording plane (z-direction), and in an x- and y-direction (that is to say in the image recording plane). This can be achieved, for example, by spring elements, in particular metal springs. Shock absorber elements based on elastomers also come into consideration. However, other configurations of shock absorber elements can also be imagined of course.

As FIG. 2 further shows, the housing 2 essentially comprises a housing shell 14 and a removable housing shell 13. A bearing surface 18 for supporting the shock absorber element 8 is arranged on the housing shell 14. It is to be seen that in a rest position the bearing surface 18, the image recording plane of the X-ray sensor 3 and the transmission unit 6 run in plane-parallel fashion relative to one another. The shock absorber elements 7 and 8 are supported on one side on a top side, assigned to the holding arrangement 4 or to the X-ray sensor 3, respectively, of the transmission unit 6.

The schematic sketch in accordance with FIG. 2 permits various structural refinements. Thus, for example, it is not necessary for the shock absorber elements 7 and 8 to be of different design. It could even be advantageous to assemble the shock absorber elements 7 and 8 from identical or similar components.

The Bucky 1 in accordance with FIG. 3 differs from FIG. 2 to the effect that an additional shock absorber arrangement is provided. This can include spring elements 26 that respectively connect one side of the holding arrangement to the housing 1. It is to be seen in this case that the spring element 26 has a spring axis A that runs along one side of the holding arrangement and in a parallel plane relative to the image recording plane of the X-ray image sensor 3 (compare FIG. 5).

As FIGS. 4 and 5 show, the transmission unit 6 is configured as a rectangular carrier ring or carrier frame 9. Four shock absorber elements 7 and 8 are respectively fastened thereon, for example by quick-acting closures. These shock absorber elements respectively include a conically designed spring element. The carrier ring 9 can consist of a metallic material, for example of steel or of aluminum. Also to be seen as spring elements are three wire cable spring elements 26 whose spring axes run along a side of the holding arrangement 4 and in a parallel plane relative to the image recording plane of the X-ray image sensor 3. It emerges from FIG. 5, in particular, that a wire cable spring element 26 is respectively arranged in the region of the side of the holding arrangement opposite the holding arm 16, and in the region of the transverse sides of the holding arrangement adjoining said side. These wire cable spring elements form a third shock absorber arrangement that acts like a second damping stage that comes to bear particularly in the event of shocks with a relatively long travel.

FIGS. 6 and 7 once again show the Bucky 1, but without the shells and without electronics. The basic mechanical structure of the Bucky is rendered visible in this way. As may be seen, shock absorber elements 8 are arranged in the region of the corners of the carrier ring 9. On its frame sections running along the transverse sides of the holding element, the carrier ring respectively has two cutouts 31, denoted by 31, for fastening corresponding shock absorber elements by means of a quick-acting closure. As can be seen, the shock absorber elements 8 are connected to the carrier ring 9 with the aid of a similar quick-acting closure.

As FIGS. 8 and 9 show, the shock absorber elements 7 and 8, respectively, substantially comprise a conical helical compression spring 10 that are arranged for supporting purposes between a first supporting element 19 and a second supporting element 22. The first supporting element 19 is designed in the shape of a disk and has a circular outer contour. It can be connected with the aid of fastening screws (FIG. 3*) either to the holding arrangement or to the fastening corner element. A corresponding receptacle 21 for the fastening screw 20 is in FIG. 9. The conical helical compression spring 10 shown. As FIG. 9 further shows, the spring element 10 is fixed by a shoulder 25 on the first supporting element 19. Provided on the other side of the helical compression spring 10 is a centering section 23 for positioning on the second supporting element 22. The shock absorber element is secured by securing means 11. These can be designed, for example, as chain cables (see preceding FIGS. 4 and 5) or steel cables.

It is to be seen from FIG. 12 that the motion detector 32 can be designed as a laser light barrier. The laser light barrier generates an outwardly directed laser beam (indicated by an arrow) with the aid of which movements in the surroundings of the housing can be advantageously detected. The motion detector 32 is connected to a control unit (not shown) in particular for controlling the radiographic operation.

1-17. (canceled)

18. A device for generating X-ray images, having a housing in which an X-ray imager is arranged, and having a holding arrangement on which the X-ray imager can be fixed in a recording position, wherein the housing is fastened on the holding arrangement via a floating and/or oscillating suspension.

19. A device as claimed in claim 18, wherein the holding arrangement is height-adjustable and/or rotatable.

20. The device as claimed in claim 18, wherein the X-ray image sensor is assigned to the holding arrangement.

21. The device as claimed in claim 18, wherein the holding arrangement is connected to a transmission unit by a first shock absorber arrangement having at least one shock absorber element, and wherein the transmission unit is connected to the housing by a second shock absorber arrangement having at least one shock absorber element.

22. The device as claimed in claim 21, wherein the trans-mission unit is of rigid design.

23. The device as claimed in claim 21, wherein the trans-mission unit is a carrier ring.

24. The device as claimed in claim 21, wherein the shock absorber elements are supported on one side on a top side, facing the holding arrangement, of the transmission unit.

25. The device as claimed in claim 21, wherein in order to support the shock absorber elements of the second shock absorber arrangement there is provided on the housing a bearing surface which in a rest position is approximately plane-parallel relative to the image recording plane of the X-ray image sensor.

26. The device as claimed in claim 21, wherein the shock absorber elements of the first shock absorber arrangement, and/or the shock absorber elements of the second shock absorber arrangement include spring elements.

27. The device as claimed in claim 26, wherein each shock absorber element of the first shock absorber arrangement and/or each shock absorber element of the second shock absorber arrangement respectively have/has a spring element.

28. The device as claimed in claim 26, wherein the shock absorber elements of the first shock absorber arrangement, and the shock absorber elements of the second shock absorber arrangement include spring elements whose spring axes run perpendicular to the image recording plane of the X-ray image sensor in the rest position.

29. The device as claimed in claim 27, wherein the shock absorber elements are provided with securing means in order to restrict the movement of the housing and/or of the transmission unit in the event of shocks.

30. The device as claimed in claim 18, wherein the holding arrangement is connected to the housing on at least one side by at least one additional spring element.

31. The device as claimed in claim 30, wherein at least one wire cable spring element is respectively arranged in the region of the side of the holding arrangement opposite a holding arm, and in the region of the transverse sides of the holding arrangement adjoining said side.

32. The device as claimed in claim 18, wherein the housing is assembled from two housing shells.

33. The device as claimed in claim 18, wherein at least one outwardly directed motion detector for monitoring movements in the surroundings of the housing is provided on the housing.

34. The device as claimed in claim 18, wherein provided in the housing is at least one sensor for monitoring shocks which is fastened on the holding arrangement and can pick up movements of the transmission unit and/or of the housing.

35. An X-ray machine having a radiation source for emitting X-rays, and having a device for generating real-time X-ray images, wherein the motion detector and/or the sensor for monitoring shocks is connected to a control unit via which a radiographic procedure can be switched off automatically upon signaling of movements in the surroundings of the housing or given critical shocks, and wherein
the device has a housing in which an X-ray imager is arranged,
the device has a holding arrangement on which the X-ray imager can be fixed in a recording position,
the housing is fastened on the holding arrangement via a floating and/or oscillating suspension, and at least one outwardly directed motion detector for monitoring movements in the surroundings of the housing is provided on the housing.
